(19) United States
(12) Patent Application Publication
(10) Pub. No.: US 2019/0018666 A1
(43) Pub. Date: Jan. 17, 2019

(54) MOBILE TERMINAL APPLICATION UPDATE METHOD AND DEVICE

(71) Applicant: Alibaba Group Holding Limited, George Town (KY)

(72) Inventor: Ding Sheng, Hangzhou (CN)

(73) Assignee: Alibaba Group Holding Limited, George Town (KY)

(21) Appl. No.: 16/131,905

(22) Filed: Sep. 14, 2018

Related U.S. Application Data
(63) Continuation of application No. PCT/CN2017/075464, filed on Mar. 2, 2017.

(30) Foreign Application Priority Data
Mar. 15, 2016 (CN) 201610147375.X

(51) Int. Cl. G06F 8/65; G06F 17/30; H04L 29/08

(52) U.S. Cl. CPC G06F 8/65; G06F 17/30153; H04L 67/02; H04L 67/06; H04L 67/34

(57) ABSTRACT

The present application provides a mobile terminal application update method and device. An offline compressed package that includes one or more files having one or more file types is received by a computing device from a server over a network. The offline compressed package is decompressed by the computing device into a decompressed package that includes the one or more files. A file type of each file included in the decompressed package is identified by the computing device. Each file included in the decompressed package is sent to a particular container associated with the identified file type of the file. The particular container is included in a plurality of containers each associated with a particular file type. The particular container is configured to execute the file to perform an update action on the computing device.

### CROSS-REFERENCE TO RELATED APPLICATIONS

This application is a continuation of PCT Application No. PCT/CN2017/075464, filed on Mar. 2, 2017, which claims priority to Chinese Patent Application No. 201610147375.X, filed on Mar. 15, 2016, and each application is hereby incorporated by reference in its entirety.

### TECHNICAL FIELD

The present application relates to the field of computer technologies, and in particular, to a mobile terminal application update method and device.

### BACKGROUND

With the rapid development of Internet technologies, users can implement various service operations by using applications installed on mobile terminals, for example, a payment operation and a shopping operation. In the related technologies, to fix current-version defects or to improve a current version, the developer usually updates applications after the applications are released. How to improve development efficiency during application updating becomes a problem to be resolved.

### SUMMARY

The present application provides a mobile terminal application update method and device.

The present application is implemented by using the following technical solutions:

A mobile terminal application update method is provided, and the method includes the following: downloading an offline compressed package from a server, where the offline compressed package includes one or more types of files; identifying a file type of each file in the offline compressed package after the offline compressed package is decompressed; and sending the file to a container that matches the file type for running to complete updating.

Optionally, the identifying a file type of each file in the offline compressed package includes the following: identifying the file type of each file based on a suffix of the file in the offline compressed package.

Optionally, the sending the file to a container that matches the file type for running includes sending the file to a WebView container for running when the file is a Hypertext Markup Language (HTML) file.

Optionally, the sending the file to a container that matches the file type for running includes sending the file to a. React-Native container for running when the file is a React-Native file.

A mobile terminal application update device is provided, and the device includes the following: a download unit, configured to download an offline compressed package from a server, where the offline compressed package includes one or more types of files; an identification unit, configured to identify a file type of each file in the offline compressed package after the offline compressed package is decompressed; and a running unit, configured to send the file to a container that matches the file type for running, to complete updating.

Optionally, the identification unit is configured to identify the file type of each file based on a suffix of the file in the offline compressed package after the offline compressed package is decompressed.

Optionally, the running unit is configured to send the file to a WebView container for running when the file is an HTML file.

Optionally, the running unit is configured to send the file to a React-Native container for running when the file is a React-Native file.

It can be seen from the previous descriptions that the developer in the present application can pack different types of files into the same offline compressed package without distinguishing the file types, thereby improving development efficiency of the developer. In the present application, an application can identify the file type of each file in the offline compressed package after downloading the offline compressed package, and send the file to the container that matches the file type for running, to update the application without decompressing a plurality of offline compressed packages, thereby improving an application update rate.

### BRIEF DESCRIPTION OF DRAWINGS

FIG. 1 is a schematic flowchart illustrating a mobile terminal application update method, according to an example implementation of the present application;

FIG. 2 is a schematic structural diagram illustrating a mobile terminal application update device, according to an example implementation of the present application;

FIG. 3 is a schematic structural diagram illustrating a mobile terminal application update device, according to an example implementation of the present application; and

FIG. 4 is a flowchart illustrating an example of a computer-implemented method for sending each file originating from an offline compressed package to a particular container associated with a file type of the file, according to an implementation of the present disclosure.

### DESCRIPTION OF IMPLEMENTATIONS

Example implementations are described in detail here, and examples of the implementations are indicated in the accompanying drawings. When the following descriptions relate to the accompanying drawings, the same number in different accompanying drawings indicates the same or similar element unless otherwise specified. Implementations described in the following example implementations do not represent all implementations consistent with the present application. Instead, these implementations are merely examples of devices and methods consistent with some aspects of the present application, as described in detail in the appended claims.

The terms used in the present application are merely for illustrating specific implementations, and are not intended to limit the present application. The terms “a”, “said”, and “the” of singular forms used in the present application and the appended claims are also intended to include plural forms, unless otherwise specified in the context clearly. It should be further understood that, the term “and/or” used in the specification indicates and includes any or all possible combinations of one or more associated listed items.

It should be understood that although terms “first”, “second”, “third”, etc. can be used in the present application to describe various types of information, the information is not limited to the terms. These terms are only used to distinguish information of the same type. For example, without departing from the scope of the present application, first information can also be referred to as second information, and similarly, second information can also be referred to as first information. Depending on the context, for example, the word “if” used here can be explained as “while”, “when”, or “in response to determining”.

In the related technologies, a developer usually packs different types of files separately when updating an application. For example, assume that two types of files need to be run to update a certain application: an HTML5 file and a React-Native file. Currently, the developer usually packs the two types of files separately. The application downloads two offline compressed packages from a server. Corresponding containers run the two offline compressed packages to complete updating after the two offline compressed packages are separately decompressed. However, in this implementation, separately packing different types of files can seriously affect development efficiency of the developer when there are many file types or the application is frequently updated. In addition, an application update rate is also affected because a plurality of offline compressed packages downloaded by the application need to be separately decompressed for running.

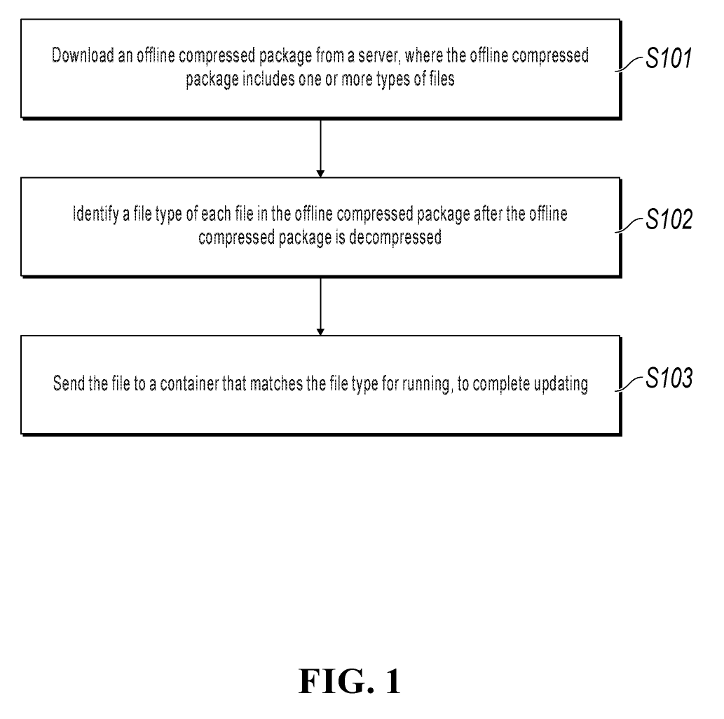

To resolve the described problems, the present application provides a mobile terminal application update method. Referring to FIG. 1, FIG. 1 is a schematic flowchart illustrating a mobile terminal application update method, according to an example implementation of the present application. The mobile terminal application update method can be applied to an application (APP) installed on a mobile terminal. The mobile terminal can include an intelligent terminal device such as a smartphone, a tablet computer, a personal digital assistant (PDA), or a PC. The mobile terminal application update method can include the following steps.

Step 101: Download an offline compressed package from a server, where the offline compressed package includes one or more types of files.

In this implementation, when preparing an offline compressed package needed for updating the APP, the developer of the APP can compile related files needed for updating and pack all the files into the same offline compressed package.

In this implementation, updating the APP usually needs running various types of files, for example, an HTML5 file and a React-Native file. The developer can compile the various types of files and pack all the files needed for current APP updating into the same offline compressed package.

In this implementation, the APP can download the offline compressed package needed for updating from the server after receiving a version update message pushed by the server. The offline compressed package includes the one or more types of files.

Step 102: Identify a file type of each file in the offline compressed package after the offline compressed package is decompressed.

Based on step 101, all the files included in the downloaded offline compressed package can be obtained after the offline compressed package is decompressed. In the present step, the file type of each file can be identified. Optionally, the file type can be identified based on a suffix of the file.

For example, the file can be determined as an HTML file when the suffix of the file is .html; or the file can be determined as a React-Native file when the suffix of the file is .jsbundle. Certainly, in actual applications, there can be other types of files. Details are omitted in the present application for simplicity.

Step 103: Send the file to a container that matches the file type for running, to complete updating.

Based on an identification result of step 102, the file can be sent to the container that matches the file type after the file type of the file is identified. The container runs the file to update the APP.

In this implementation, the file can be sent to a WebView container when the file is an HTML file, and the WebView container can run code in the HTML file. The file can be sent to a React-Native container when the file is a React-Native file, and the React-Native container can run code in the React-Native file. A similar operation is applied to other types of files. Details are omitted in the present application for simplicity. After each file in the offline compressed package is run by the container that matches the file type, the APP update is complete.

It can be seen from the previous descriptions that the developer in the present application can pack different types of files into the same offline compressed package without distinguishing the file types, thereby greatly improving development efficiency of the developer. In the present application, the APP can identify the file type of each file in the offline compressed package after downloading the offline compressed package, and send the file to the container that matches the file type for running, to update the APP without decompressing a plurality of offline compressed packages, thereby improving an application update rate.

Corresponding to the implementation of the mobile terminal application update method, the present application further provides an implementation of a mobile terminal application update device.

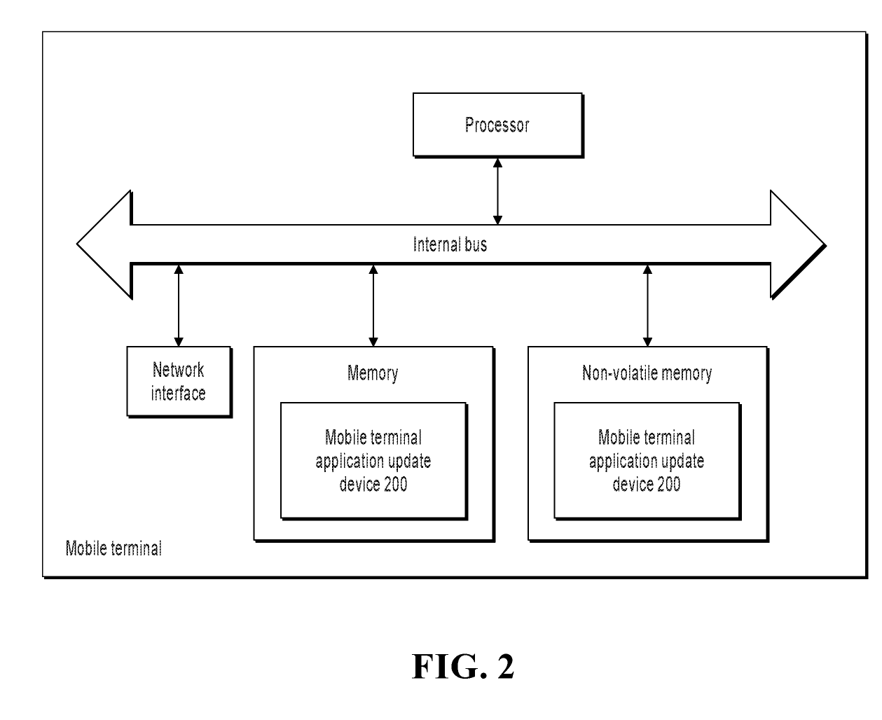

The implementation of the mobile terminal application update device in the present application can be applied to an APP installed on a mobile terminal. The device implementation can be implemented by software, hardware, or a combination of hardware and software. Software implementation is used as an example. As a logical device, the software is formed by reading a corresponding computer program instruction from a nonvolatile memory and running the instruction in a memory by a processor in the mobile terminal. In terms of hardware, as shown in FIG. 2, FIG. 2 is a hardware structural diagram illustrating a mobile terminal with a mobile terminal application update device, according to the present application. In addition to a processor, a memory, a network interface, and a nonvolatile memory shown in FIG. 2, the mobile terminal with the device in the implementation can further include other hardware based on actual functions of the mobile terminal. Details are omitted here for simplicity.

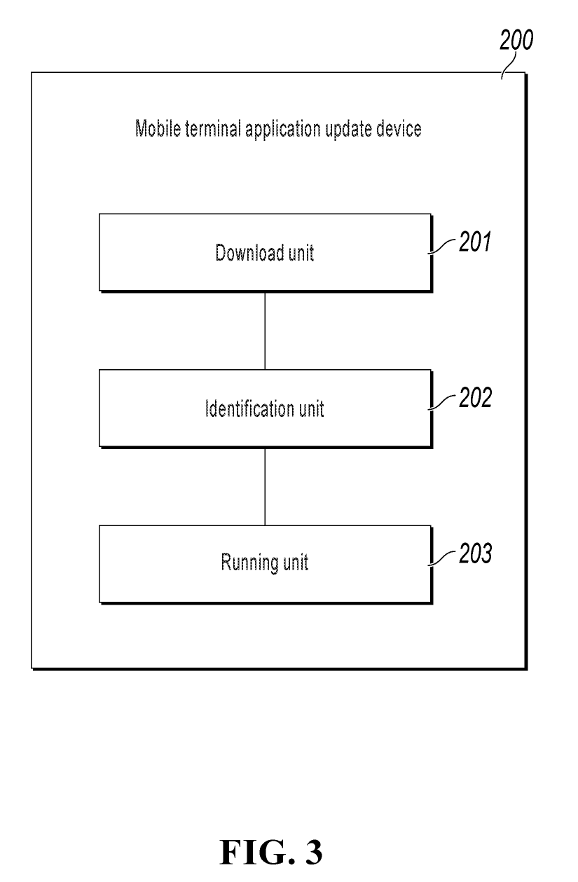

FIG. 3 is a schematic structural diagram illustrating a mobile terminal application update device, according to an example implementation of the present application.

Referring to FIG. 3, the mobile terminal application update device 200 can be applied to the APP installed on the mobile terminal shown in FIG. 2, and includes a download unit 201, an identification unit 202, and a running unit 203.

The download unit 201 is configured to download an offline compressed package from a server, where the offline compressed package includes one or more types of files.

The identification unit 202 is configured to identify a file type of each file in the offline compressed package after the offline compressed package is decompressed.

The running unit 203 is configured to send the file to a container that matches the file type for running, to complete updating.

Optionally, the identification unit 202 is configured to identify the file type of each file based on a suffix of the file in the offline compressed package after the offline compressed package is decompressed.

Optionally, the running unit 203 is configured to send the file to a WebView container for running when the file is an HTML file.

Optionally, the running unit 203 is configured to send the file to a React-Native container for running when the file is a React-Native file.

For an implementation process of functions and roles of each unit in the device, reference can be made to an implementation process of corresponding steps in the previous method. Details are omitted here for simplicity.

Because a device implementation basically corresponds to a method implementation, for related parts, reference can be made to related descriptions in the method implementation. The previously described device implementation is merely an example. The units described as separate parts can or cannot be physically separate, and parts displayed as units can or cannot be physical units, can be located in one position, or can be distributed on a plurality of network units. Some or all of the modules can be selected based on actual needs to achieve the objectives of the solutions in the present application. A person of ordinary skill in the art can understand and implement the present application without creative efforts.

The previous descriptions are merely implementations of the present application, and are not intended to limit the present application. Any modification, equivalent replacement, or improvement made without departing from the spirit and principle of the present application should fall within the protection scope of the present application.

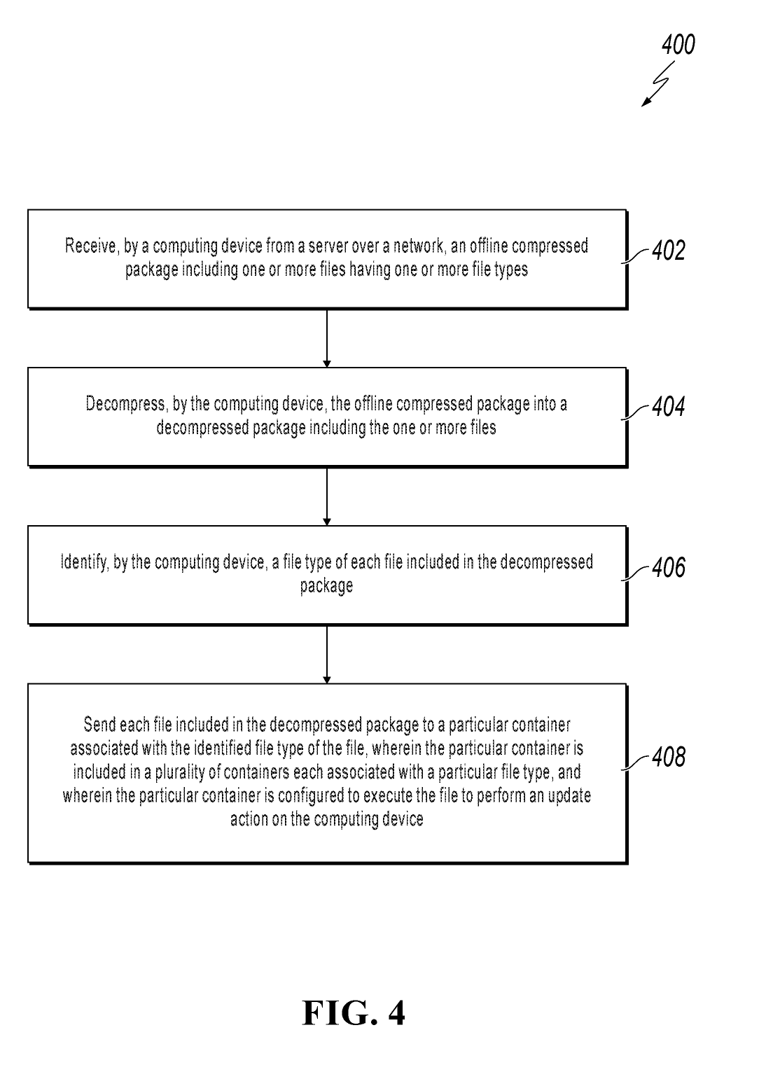

FIG. 4 is a flowchart illustrating an example of a computer-implemented method 400 for sending each file originating from an offline compressed package to a particular container associated with a file type of the file, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various steps of method 400 can be run in parallel, in combination, in loops, or in any order.

At 402, an offline compressed package that includes one or more files having one or more file types is received by a computing device from a server over a network. As an example, an APP that is running on the computing device, such as a user's mobile device, can trigger the download unit 201 to download the offline compressed package. The offline compressed package may be used, for example, to update the APP that is running on the computing device.

In some implementations, receiving the offline compressed package can include downloading, by a mobile terminal application, the offline compressed package from the server. For example, the download unit 201 can be configured to download the offline compressed package from a server that is accessible to the computing device through a network.

In some implementations, the one or more files in the offline compressed package can include a first file having a first file type and a second file having a second file type. In these and other implementations, the first file is different than the second file, and the first file type is different than the second file type. As an example, the first file type of the first file can be one file type (for example, HTML), and the second file type of the second file can be a different file type (for example, React Native). The first file and the second file can be configured, when executed, to perform update actions included in an update task associated with the computing device. From 402, method 400 proceeds to 404.

At 404, the offline compressed package is decompressed by the computing device into a decompressed package that includes the one or more files. As an example, a decompression application executing on the user's mobile device can decompress the offline compressed package to create a decompressed package that includes decompressed files. From 404, method 400 proceeds to 406.

At 406, a file type of each file included in the decompressed package is identified by the computing device. For example, the APP on the user's mobile device can invoke the identification unit 202 to identify a file type of each file in the offline compressed package after the offline compressed package is decompressed. The file type identification information can be used in combination with the offline compressed package to identify the file types of the files included in the offline compressed package.

In some implementations, identifying the file type of the given file can include identifying the file type of the given file based on a suffix of the given file. As an example, the file type of the file can be determined by the identification unit 202 to be HTML when the suffix of the file is .html. In another example, the file type of the file can be determined by the identification unit 202 to be React-Native when the suffix of the file is .jsbundle. From 406, method 400 proceeds to 408.

At 408, each file included in the decompressed package is sent to a particular container associated with the identified file type of the file. The particular container is included in a plurality of containers that are each associated with a particular file type. The particular container is configured to execute the file to perform an update action (corresponding to the file type) on the computing device. Different containers on the user's mobile device may be reserved for different uses, including being containers for different file types. As an example, the particular container can be a WebView container for running a WebView-related update action when the file type of the given file is an HTML file type. In another example, the particular container can be a React Native container for running a React Native-related update action when the file type of the given file is a React Native file type. As a result, the running unit 203 can be configured to send React-Native files to a React-Native container, HTML files to a WebView container, and other file types to corresponding containers as needed. After 408, method 400 stops.

In the present disclosure, an application can identify the file type of each file in the offline compressed package after downloading the offline compressed package and without decompressing the compressed package. Each file can be sent to a container that matches the file type and that is configured to execute the file to perform an update action on the computing device. Such techniques can improve an application update rate and overall response times for a user. Further, the file type identification information can be used in combination with the offline compressed package to tag the file types of the files included in the offline compressed package.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
receiving, by a computing device from a server over a network, an offline compressed package including one or more files having one or more file types;
decompressing, by the computing device, the offline compressed package into a decompressed package including the one or more files;
identifying, by the computing device, a file type of each file included in the decompressed package; and
sending each file included in the decompressed package to a particular container associated with the identified file type of the file, wherein the particular container is included in a plurality of containers each associated with a particular file type, and wherein the particular container is configured to execute the file to perform an update action on the computing device.

2. The computer-implemented method of claim 1, wherein identifying the file type of each file comprises identifying the file type of the file based on a suffix of the given file.

3. The computer-implemented method of claim 1, wherein the particular container is a WebView container when the file type of the file is a Hypertext Markup Language (HTML) file type.

4. The computer-implemented method of claim 1, wherein the particular container is a React Native container when the file type of the file is a React Native file type.

5. The computer-implemented method of claim 1, wherein receiving the offline compressed package includes downloading, by a mobile terminal application, the offline compressed package from the server.

6. The computer-implemented method of claim 1, wherein the one or more files in the offline compressed package include a first file having a first file type and a second file having a second file type, wherein the first file is different than the second file, and wherein the first file type is different than the second file type.

7. The computer-implemented method of claim 6, wherein the first file and the second file are operable, when executed, to perform update actions included in an update task associated with the computing device.

8. A non-transitory, computer-readable medium storing one or more instructions executable by a computer system to perform operations comprising:
receiving, by a computing device from a server over a network, an offline compressed package including one or more files having one or more file types;
decompressing, by the computing device, the offline compressed package into a decompressed package including the one or more files;
identifying, by the computing device, a file type of each file included in the decompressed package; and
sending each file included in the decompressed package to a particular container associated with the identified file type of the file, wherein the particular container is included in a plurality of containers each associated with a particular file type, and wherein the particular container is configured to execute the file to perform an update action on the computing device.

9. The non-transitory, computer-readable medium of claim 8, wherein identifying the file type of each file comprises identifying the file type of the file based on a suffix of the given file.

10. The non-transitory, computer-readable medium of claim 8, wherein the particular container is a WebView container when the file type of the file is a Hypertext Markup Language (HTML) file type.

11. The non-transitory, computer-readable medium of claim 8, wherein the particular container is a React Native container when the file type of the file is a React Native file type.

12. The non-transitory, computer-readable medium of claim 8, wherein receiving the offline compressed package includes downloading, by a mobile terminal application, the offline compressed package from the server.

13. The non-transitory, computer-readable medium of claim 8, wherein the one or more files in the offline compressed package include a first file having a first file type and a second file having a second file type, wherein the first file is different than the second file, and wherein the first file type is different than the second file type.

14. The non-transitory, computer-readable medium of claim 13, wherein the first file and the second file are operable, when executed, to perform update actions included in an update task associated with the computing device.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a computing device from a server over a network, an offline compressed package including one or more files having one or more file types;
decompressing, by the computing device, the offline compressed package into a decompressed package including the one or more files;
identifying, by the computing device, a file type of each file included in the decompressed package; and
sending each file included in the decompressed package to a particular container associated with the identified file type of the file, wherein the particular container is included in a plurality of containers each associated with a particular file type, and wherein the particular container is configured to execute the file to perform an update action on the computing device.

16. The computer-implemented system of claim 15, wherein identifying the file type of each file comprises identifying the file type of the file based on a suffix of the given file.

17. The computer-implemented system of claim 15, wherein the particular container is a WebView container when the file type of the file is a Hypertext Markup Language (HTML) file type.

18. The computer-implemented system of claim 15, wherein the particular container is a React Native container when the file type of the file is a React Native file type.

19. The computer-implemented system of claim 15, wherein receiving the offline compressed package includes downloading, by a mobile terminal application, the offline compressed package from the server.

20. The non-transitory, computer-readable medium of claim 8, wherein the one or more files in the offline compressed package include a first file having a first file type and a second file having a second file type, wherein the first file is different than the second file, and wherein the first file type is different than the second file type.
